(19) United States
(12) Patent Application Publication
(10) Pub. No.: US 2006/0282668 A1
(43) Pub. Date: Dec. 14, 2006

(54) Data encryption method and apparatus

(76) Inventor: Adam S. Leitch, Brighton (GB)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/573,722

(22) PCT Filed: Sep. 23, 2004
(86) PCT No.: PCT/IB04/51840

§ 371 Date: Mar. 27, 2006

(30) Foreign Application Priority Data
Sep. 27, 2003 (GB) 0322683.4

(51) Int. Cl. H04L 9/00

(52) U.S. Cl. 713/171

(57) ABSTRACT

A method and apparatus of encrypting data for transmission between first 1 and second 2 communication terminals in which information relating to a time at which a message sent from the first terminal is expected to arrive at the second terminal is determined by an exchange of messages between the first and second terminals. The data is encrypted at the first terminal using the determined information and is transmitted to the second terminal, where it is decrypted based on its actual arrival time.

The present invention relates to an apparatus and method for encrypting data for transmission between first and second communication terminals, and a corresponding decryption method and apparatus.

A variety of encryption techniques are known for encrypting data transmitted over a communications channel. The majority of these techniques are key based, relying on the receiving party possessing a secret key to decrypt encrypted transmissions. To provide a truly secure channel, the secret key generally needs to be provided at the receiver without transmitting it over the channel, since to do so would potentially compromise the security of the channel. This may involve physically carrying the encryption key to the receiving location. The disadvantage of requiring a physical key transfer is that it makes it very difficult to establish dynamic communication channels, or to change the encryption method frequently.

The present invention aims to address the above problems.

According to the invention, there is provided a method of encrypting data for transmission between first and second communication terminals, the method comprising the steps of determining information relating to a time at which a message sent from the first terminal will arrive at the second terminal and encrypting the data at the first terminal using the determined information.

There is correspondingly provided a method of decrypting encrypted data received from a first communication terminal at a second communication terminal, in which the data has been encrypted at the first terminal using information relating to the time at which the data is expected to be received at the second terminal, comprising the steps of receiving the encrypted data at the second terminal, determining information relating to the time of receipt of the encrypted data and using the determined information to decrypt the encrypted data.

By encrypting the data based on its arrival time at the second communication terminal, a secure channel can be established, since only the second communication terminal will receive the information at the determined time and therefore be able to decrypt it.

The step of determining the expected time of arrival at the second terminal may comprise transmitting a first message from the first communication terminal to the second communication terminal, receiving a reply message from the second communication terminal, the reply message including information relating to the receipt time of the first message at the second terminal and information relating to a transmission time of the reply message and determining the time of receipt of the reply message at the first communication terminal. In combination with the transmission time of the first message, this provides the information required to calculate the expected time of arrival of a message sent from the first terminal to the second terminal.

According to the invention, there is also provided a method of setting up a secure channel between first and second communication terminals in a communication system, the method comprising the steps of receiving a first message sent from the first terminal at the second terminal and transmitting a second message from the second terminal to the first terminal, including information relating to the time of arrival of the first message at the second terminal and the time of transmission of the second message from the second terminal to the first terminal.

A secure channel may therefore be set up by a simple message exchange between first and second terminals.

The method according to the invention may permit only the first terminal to acquire the information required to encrypt data for the second terminal.

According to the invention, there is further provided a communication system in which data is to be encrypted for transmission between first and second communication terminals, the system comprising means for determining information relating to a time at which a message sent from the first terminal is expected to arrive at the second terminal and means for encrypting the data at the first terminal using the determined information.

The first and second terminals may have first and second internal clocks respectively, each of which generates a sequence of values corresponding to a time sequence. Since the clock values are constantly changing, an encryption method that relies on encrypting data based on an encryption key related to the expected clock value on receipt of the data, may have the advantage that the encryption key may change on transmission of each data packet.

There is still further provided, in accordance with the invention, a transmitter configured to transmit encrypted data to a receiver, the transmitter comprising means for determining information relating to a time at which a message sent from the transmitter is expected to arrive at the receiver and means for encrypting the data at the transmitter using the determined information.

The invention also provides a receiver configured to decrypt data sent from a transmitter, wherein the data is encrypted using information relating to a time at which a message sent from the transmitter is expected to arrive at the receiver, the receiver comprising means for receiving the encrypted data, means for determining a time of arrival of the encrypted data and means for decrypting the encrypted data using the determined information.

Embodiments of the invention will now be described by way of example, with reference to the accompanying drawings, in which:

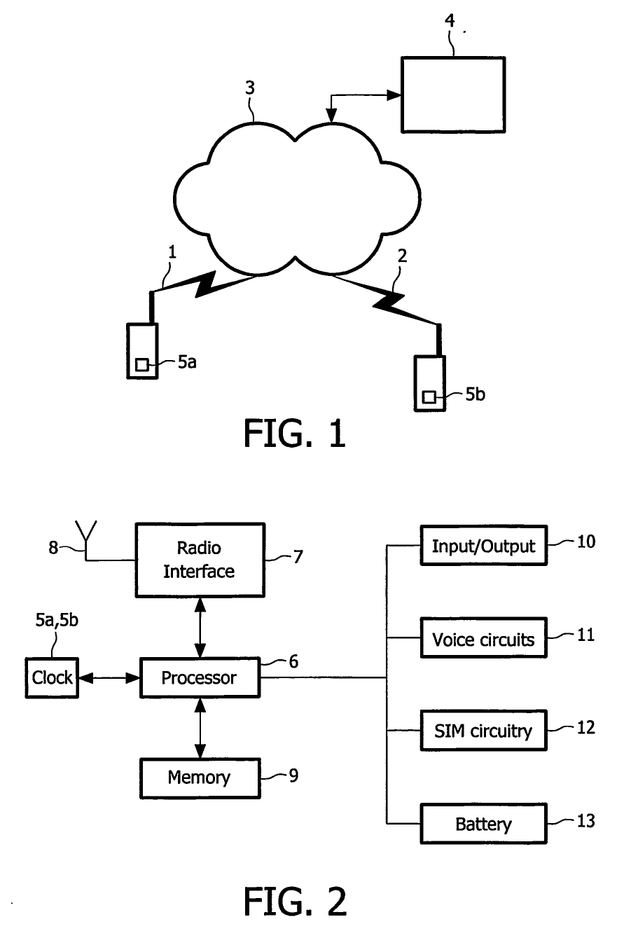

FIG. 1 is a schematic diagram of a communications system according to the invention, including first and second communication terminals;

FIG. 2 is a schematic block diagram illustrating the internal architecture of each of the first and second communication terminals of FIG. 1;

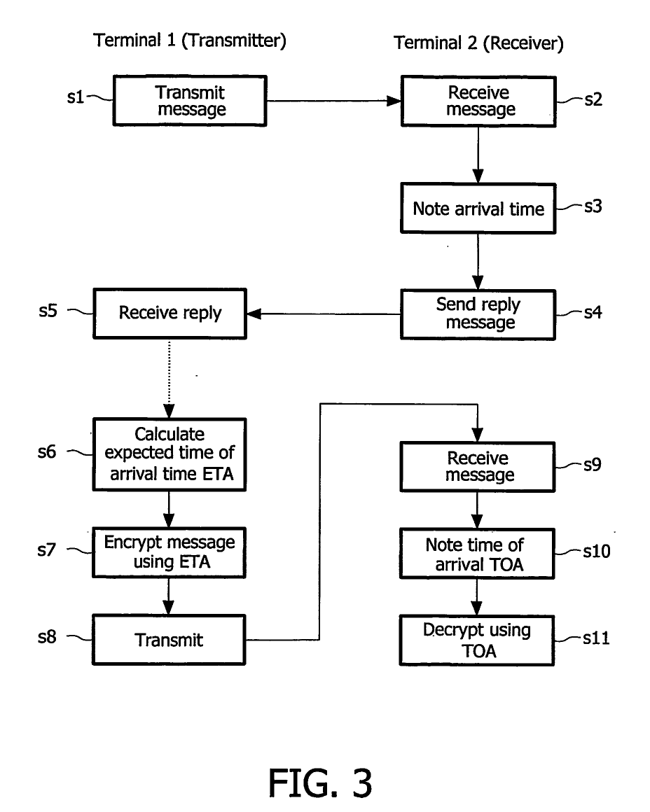

FIG. 3 is a flow diagram illustrating the encryption and corresponding decryption of data transmitted between the first and second terminals shown in FIG. 1; and

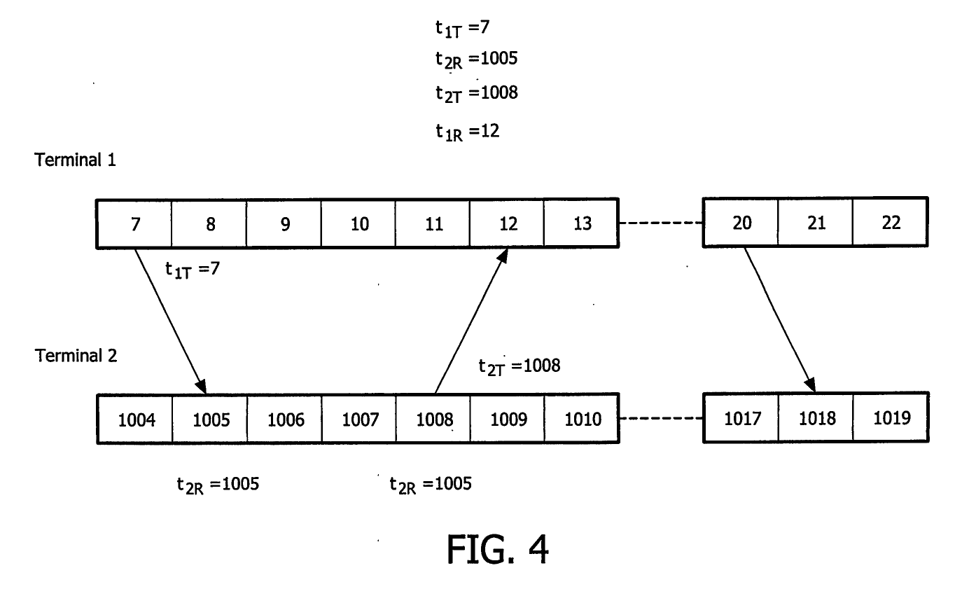

FIG. 4 is a schematic diagram illustrating clock sequences at each of the first and second communication terminals.

Referring to FIG. 1, a system according to the invention comprises first and second wireless user terminals 1, 2 communicating via a communications network 3 under the control of a base station 4, using any available communications protocol, including but not limited to GSM and UMTS. Each of the first and second user terminals 1, 2 has a respective internal clock 5a, 5b, which maintains an internal time reference.

The internal architecture of each of the user terminals 1, 2 is shown in block diagram form in FIG. 2. Each terminal includes a clock circuit 5a, 5b, a processor 6, radio interface circuitry 7, an antenna 8, memory 9, input/output circuitry 10, including for example, a display, keypad, speaker and microphone, voice circuits 11, authentication circuitry 12, including for example a SIM card and reader, and a battery 13.

The way in which the user terminal described above communicates with other user terminals in accordance with any particular protocol is well known and will not be described in detail further.

The internal clock circuits 5a, 5b shown in FIG. 2 generate a clock sequence which is not synchronised with and therefore independent of the clock sequence of any other user terminal, depending, for example, on when each user terminal is switched on. Each user terminal therefore has a different perception of time. To permit encryption in accordance with the invention, the first user terminal 1 must first acquire the second user terminal's 2 time perception.

FIG. 3 illustrates steps carried out by the circuitry of FIG. 2 under the control of the processor 6 based, for example, on software stored in the memory 9. Referring to FIG. 3, the first user terminal 1 transmits a non-secure message to the second user terminal 2 at a transmission time designated t_{1T} according to the first user terminal's clock 5a (step s1). The transmission time is encoded into the message. The suffix ‘1T’ indicates transmission from the first terminal 1. The message is received at the second terminal 2 (step s2), which notes the time of arrival, designated t_{2R} (step s3). The suffix ‘2R’ indicates that the message has been received at the second terminal 2. The second terminal 2 then replies to the first terminal 1 with a message including the initial transmission time t_{1T}, the time of arrival t_{2R} and the time of transmission of the reply message t_{2T} (step s4). This reply message is received at the first terminal 1 at time t_{1R} (step s5). The first terminal 1 now has sufficient information to calculate the offset between the respective clocks 5a, 5b, also referred to herein as the transmit 5a and receive 5b clocks.

In an alternative example, which may enhance the security of the system further, the initial transmission time t_{1T} is not included in the message sent from the first terminal, but is stored at the first terminal 1. When a reply message is received from the second terminal 2, the first terminal 1 retrieves the transmission time of the initial message corresponding to the reply message. This can be achieved by any method that allows the first terminal 1 to identify the transmission time of the initial message on receipt of the reply message. For example, on transmission, the first terminal 1 stores a message identifier with the transmission time t_{1T} and sends the message identifier to the second terminal. The second terminal 2 inserts the message identifier into the reply message and returns this to the first terminal 1 along with the time of arrival t_{2R} and reply message time of transmission t_{2T} information. On receipt of the reply message, the first terminal 1 looks up the transmission time t_{1T} corresponding to the message identifier.

As a further alternative, the message sent by the first terminal 1 is a wake-up message to the second terminal 2. The transmission time t_{1T} is stored at the first terminal together with an identifier for the second terminal 2. In this case, the identifier of the terminal 2 from which a reply message is received is used to look up the initial transmission time.

The first terminal 1 now has the following information: t_{1T}, t_{2R}, t_{2T} and t_{1R}. The total time taken for a response to a message transmitted from the first terminal 1 to be received at the first terminal 1 is given by the equation:
T_{Total}=T₁₂+T_{(2R/T)}+T₂₁ (Equation 1)
where:
T₁₂ is the time of flight for a message initiated at the first user terminal to travel to the second user terminal,
T_{(2R/T)} is the internal transit time interval between a message being received at the second terminal and a reply being transmitted from the second terminal; and
T₂₁ is the time of flight for a message initiated at the second user terminal to travel to the first user terminal.

However, on the assumption that the time of flight is the same in both directions, then T₁₂=T₂₁. Similarly, the first terminal 1 can calculate the message transit time T_{2/RT} within the second terminal 2 as t_{2T}−t_{2R}, so that equation 1 given above reduces to:
Tₜₒₜₐₗ=2T₁₂+(t_{2T}−t_{2R}) (Equation 2)

Now, rewriting equation 2 to determine the time of flight, T₁₂, produces:

$${T}_{12} = \frac{{T}_{total} - ( {t}_{2 T} - {t}_{2 R} )}{2} \qquad ( Equation 3 )$$

Tₜₒₜₐₗ is also given by the time interval between the time at which the reply message from the second terminal was received at the first terminal and the time at which the initial message was transmitted by the first terminal, i.e. t_{1R}−t_{1T}, so that equation 3 becomes:

$${T}_{12} = \frac{( {t}_{1 R} - {t}_{1 T} ) - ( {t}_{2 T} - {t}_{2 R} )}{2} \qquad ( Equation 4 )$$

The offset between the transmit and receive clocks is given by the difference between the time at which the initial message was received at the second terminal (t_{2R}), which is expressed in the time units of the second terminal's clock 5b, and the time at which it would have been received if the second clock 5b were using the time reference of the first terminal's clock 5a, which is the transmission time t_{1T} plus the time of flight i.e. t_{1T}+T₁₂. Therefore, the offset is given by:
Offset=t_{2R}−(t_{1T}+T₁₂) (Equation 5)

Referring to FIG. 4, a specific example is given in which it is assumed that the first terminal 1 transmits a message to the second terminal 2 at local time t_{1T}=7. This is received at the second terminal 2 at local time t_{2R}=1005. There is a time gap of 3 time units until transmission of the reply message at t_{2T}=1008, the reply message including t_{1T}, t_{2R} and t_{2T}. The first terminal 1 receives the reply message at local time t_{1R}=12.

Therefore, using equation 4 given above:

$${T}_{12} = \frac{( 12 - 7 ) - ( 1008 - 1005 )}{2}$$

giving T₁₂=1.

The offset is calculated using equation 5 given above, so that:
Offset=1005−(7+1)
giving Offset =997.

Referring to FIGS. 3 and 4, when the first terminal 1 wishes to transmit data to the second terminal 2, it can use a modified form of equation 5:
t_{2RE}=t_{1TS}+time of flight+Offset (Equation 6)
where:
t_{2RE} is the expected time at which the data will be received at the second terminal 2; and
t_{1TS} is the time at which the data is scheduled to be transmitted from the first terminal 1.

Referring again to FIG. 3, for a message to be sent at a scheduled transmission time t_{1TS}, the first terminal therefore calculates the expected arrival time t_{2RE} at the second terminal 2 by adding the previously calculated Offset and time of flight to the scheduled transmission time t_{1TS} (step s6).

The message to be sent is then encrypted using the expected arrival time (step s7), the message is transmitted at the scheduled transmission time (step s8) and is received by the second terminal 2 (step s9) at an actual arrival time which is the same as the expected arrival time. The actual time of arrival (TOA) is recorded (step s10) and used to decrypt the message (step s11).

The encryption/decryption can be done in numerous ways. For example, the data to be transmitted is multiplied by the expected arrival time, transmitted and then divided by the actual arrival time at the receiving end. However, any technique could be used which results in the data being amended in some way depending on the relative difference between the internal clocks, including summation, using a look-up table or any other technique for manipulating data.

For example, referring again to FIG. 4, assuming the first terminal 1 wishes to send data at local time t=20, it can calculate (using equation 6) that the expected time of arrival at the second terminal 2 is:
t_{2RE}=20+1+997
i.e. t_{2RE}=1018.

Therefore assuming a data packet of 101010101010, multiplication by 1018 (1111111010) results in a message packet of 1010100110100000000100. On receipt of this packet at an actual receipt time of 1018, division by this time recovers the original data packet.

In the absence of information as to the clock reading on receipt, no other receiver can successfully decode this information. Since the transmitter and receiver clocks 5a, 5b are constantly moving, the multiplying factor, which can be considered as an encryption key, is changed every time the transmission time of a data packet changes, providing a further enhancement in security.

In the arrangement described, the receiving terminal 2 does not have sufficient information to be able to encrypt data for transmission to the first terminal 1. To do this, it needs to send a message to the first terminal 1 and wait for a reply, by analogy with the reverse process described above.

The system according to the invention can be used to send voice or data securely. An exchange of messages between two terminals is all that is required to set up a secure channel, so that the system could allow secure. transmission over walkie-talkies, phone-to-phone SMS messaging and so on. The system could also used as a simple initial encryption method for exchanging encryption keys. Subsequent messages encrypted using the encryption keys can be sent on the communication channel in the usual way or can use the system of the invention as a second level of encryption. The system has scope for application in any communications environment in which regular changes to encryption are desirable while it would be inconvenient to provide a physical transfer of keys to the remote receiving location.

While the invention has been described primarily in relation to wireless mobile communication terminals, it is also applicable to fixed wireless or wired terminals.

From reading the present disclosure, other variations and modifications will be apparent to persons skilled in the art. Such variations and modifications may involve equivalent and other features which are already known in the field of encryption and telecommunications and which may be used instead of or in addition to features already described herein. While the encryption method is primarily described as being implemented in software, it may alternatively be implemented in a hardware encryption module.

1. A method of encrypting data for transmission between first and second communication terminals, the method comprising the steps of:
determining information relating to a time at which a message sent from the first terminal is expected to arrive at the second terminal; and
encrypting the data at the first terminal using the determined information.

2. A method according to claim 1, further comprising determining a time of flight for a message sent from one of the first terminal and the second terminal to the other of said terminals.

3. A method according to claim 2, wherein the first and second terminals have first and second internal clocks respectively, each of which generates a sequence of values corresponding to a time sequence, further comprising the step of determining an offset value defining a difference between the sequences of the first and second clocks.

4. A method according to claim 3, wherein the step of determining the estimated time of arrival comprises adding the offset value and the time of flight to a sequence value for the first clock representing the time at which the first message is to be transmitted.

5. A method according to claim 1, wherein the step of determining information relating to a time at which the second communication terminal will receive a message sent from the first communication terminal further includes the steps of:
transmitting a first message from the first communication terminal to the second communication terminal;
receiving a reply message from the second communication terminal, the reply message including information relating to the receipt time of the first message at the second terminal and information relating to a transmission time of the reply message; and
determining the time of receipt of the reply message at the first communication terminal.

6. A method according to claim 5, further comprising including the transmission time of the first message with the first message and returning the transmission time of the first message with the reply message.

7. A method according to claim 5, including storing the transmission time of the first message at the first terminal and retrieving the transmission time on receipt of the reply message.

8. A method according to claim 5, wherein the first and second communication terminals include first and second internal clocks respectively, and the step of determining information relating to the time of receipt comprises determining a value relating to the state of the second internal clock at the time of receipt.

9. A method according to claim 1, comprising encrypting the data by combining the determined information with the data.

10. A method according to claim 9, wherein the step of combining the information with the data comprises performing a multiplication operation where a data packet is the multiplicand and the information is the multiplier.

11. A method according to claim 9, wherein the information comprises a value representing the time at which the message is expected to arrive at the second terminal.

12. A method of decrypting encrypted data received from a first communication terminal at a second communication terminal, in which the data has been encrypted at the first terminal using information relating to a time at which the data is expected to be received at the second terminal, comprising the steps of:
receiving the encrypted data at the second terminal;
determining information relating to the time of receipt of the encrypted data; and
using the determined information to decrypt the encrypted data.

13. A method according to claim 12, wherein the first and second terminals include first and second internal clocks respectively, and the step of determining information relating to the time of receipt of the encrypted data comprises determining a value relating to the state of the second internal clock at the time of receipt.

14. A method according to claim 13, wherein the step of using the determined information to decrypt the encrypted data comprises combining the data with the clock related value.

15. A method according to claim 14, wherein the step of combining the data with the clock related value comprises dividing a value representing an encrypted data packet by the clock related value.

16. A method of setting up a secure channel between first and second communication terminals in a communication system, the method comprising the steps of:
receiving a first message sent from the first terminal at the second terminal; and
transmitting a second message from the second terminal to the first terminal, the second message including information relating to the time of arrival of the first message at the second terminal and the time of transmission of the second message from the second terminal to the first terminal.

17. A method according to claim 16, further comprising the step of determining information relating to the time of transmission of the first message from the first terminal.

18. A method according to claim 17, wherein the information relating to the time of transmission is included in the first and second messages.

19. A method according to claim 17, wherein the step of determining information relating to the time of transmission of the first message comprises storing the information at the first terminal on transmission of the first message and retrieving the information from the first terminal on receipt of the second message.

20. A method according to claim 16, further comprising the step of receiving the second message at the first terminal and determining information relating to the time of receipt of the second message.

21. A communication system in which data is to be encrypted for transmission between first and second communication terminals, the system comprising:
means for determining information relating to a time at which a message sent from the first terminal is expected to arrive at the second terminal; and
means for encrypting the data at the first terminal using the determined information.

22. A system according to claim 21, wherein the determining means include:
means for transmitting a first message from the first communication terminal to the second communication terminal;
means for receiving the first message at the second communication terminal and determining a time of receipt;
means for transmitting a reply message from the second communication terminal to the first communication terminal, the reply message including information relating to the receipt time of the first message at the second terminal and information relating to a transmission time of the reply message from the second terminal; and means for receiving the reply message at the first communication terminal.

23. A system according to claim 22, wherein the first message transmitting means includes means for including the transmission time of the first message with the first message and the means for transmitting a reply message from the second terminal includes means for including the transmission time of the first message with the reply message.

24. A system according to claim 22, further comprising means for storing the transmission time of the first message at the first terminal and means for retrieving the transmission time of the first message on receipt of the reply message.

25. A system according to claim 21, wherein the first terminal includes means for transmitting the encrypted data to the second terminal.

26. A system according to claim 21, wherein the first and second terminals have first and second internal clocks respectively, each of which generates a sequence of values corresponding to a time sequence.

27. A system according to claim 26, including means for determining an offset value defining a difference between the sequences of the first and second clocks.

28. A system according to claim 27, including means for determining a propagation delay between transmission of the message by the first communication terminal and its receipt by the second communication terminal.

29. A transmitter configured to transmit encrypted data to a receiver, the transmitter comprising:
means for determining information relating to a time at which a message sent from the transmitter is expected to arrive at the receiver;
means for encrypting the data at the transmitter using the determined information.

30. A transmitter according to claim 29, further comprising means for including information relating to a transmission time of a message into the message to be transmitted.

31. A transmitter according to claim 29, further comprising means for storing information relating to a transmission time of a message.

32. A transmitter according to claim 31, further comprising means for retrieving the information relating to the transmission time of the message on receipt of the reply message.

33. A receiver configured to decrypt data sent from a transmitter, wherein the data is encrypted using information relating to a time at which a message sent from the transmitter is expected to arrive at the receiver, the receiver comprising:
means for receiving the encrypted data;
means for determining a time of arrival of the encrypted data; and means for decrypting the encrypted data using the determined information.

34. A computer program, which when run on a processor, is configured to carry out the method of claim 1.
